(19) United States
(12) Patent Application Publication
(10) Pub. No.: US 2026/0341590 A1
(43) Pub. Date: Oct. 29, 2026

(54) MAGNETIC ELEMENT WITH MAGNETIC FLUX COMPENSATION STRUCTURE AND METHOD OF MANUFACTURING THE SAME

(71) Applicant: ACBEL POLYTECH INC., New Taipei City (TW)

(72) Inventor: Hsuan-An CHEN, New Taipei City (TW)

(73) Assignee: ACBEL POLYTECH INC., New Taipei City (TW)

(21) Appl. No.: 19/573,462

(22) Filed: Mar. 20, 2026

(30) Foreign Application Priority Data
Apr. 25, 2025 (TW) 114115721

(51) Int. Cl. H01F 30/12; H01F 27/26; H01F 27/30; H01F 27/32; H01F 27/38

(52) U.S. Cl. CPC H01F 30/12; H01F 27/266; H01F 27/306; H01F 27/32; H01F 27/38

(57) ABSTRACT

The invention discloses a magnetic element with a magnetic flux compensation structure and its manufacturing method. The method involves providing a core with multiple adjacent center legs within a frame body and winding coils on each. The core is structured so that magnetic flux paths from the legs collectively pass through at least one portion of the frame body. By designing a cross-sectional area on the frame body to allow magnetic fluxes passing through to compensate for one another, a frame magnetic flux in the frame body remains lower than a maximum flux of each of the center legs, which reduces iron loss and magnetic saturation, thereby reducing the heat generated and improving the power conversion efficiency of the power converter.

### CROSS-REFERENCE TO RELATED APPLICATIONS

This application claims the priority benefit of TW application serial No. 114115721 filed on Apr. 25th, 2025, the entirety of which is hereby incorporated by reference herein and made a part of the specification.

### BACKGROUND OF THE INVENTION

### 1. Field of the Invention

The present invention relates to a magnetic element and a manufacturing method, and more particularly to a magnetic element with a magnetic flux compensation structure and a manufacturing method thereof.

### 2. Description of the Related Art

As the power demands of data centers and artificial intelligence gradually increase, power conversion efficiency of AC/DC power converters becomes more important. Since power converters generate power losses and heat during rectification, potential for system failures and reduced lifespan caused by the additional heat dissipation must be considered while designing the system.

As mentioned above, in addition to the circuit architecture and component selection, designs of magnetic components also relate to the aforementioned issues of heat dissipation, system failures, and reduced lifespan in the power converter. Furthermore, when the magnetic components experience iron losses, additional heat dissipation is generated simultaneously. The iron losses occur because the magnetic flux within the magnetic components cannot be effectively compensated and controlled.

Therefore, providing a magnetic component with a flux compensation structure and a manufacturing method thereof to improve on the above problems has become an urgent research topic.

### SUMMARY OF THE INVENTION

In view of the above problems, the present invention provides a manufacturing method of a magnetic element with a magnetic flux compensation structure.

### The manufacturing method includes steps of:

providing a core of a magnetic element; the core includes a plurality of center legs and a frame body, and each of the center legs is disposed adjacent to each other in an accommodation space of the frame body; and

winding coils on each of the center legs respectively, to form magnetic flux paths between the center legs and the frame body; when each of the coils receives a current, the coils generate magnetic fluxes along each of the magnetic flux paths.

The magnetic flux paths collectively pass through at least one portion of the frame body.

The magnetic fluxes passing through the frame body cancel each other out such that a frame magnetic flux in the frame body is smaller than a maximum value of the magnetic fluxes passing through the center legs.

The present invention further provides the magnetic element with the magnetic flux compensation structure. The magnetic element includes a core and a plurality of coils. The core includes a plurality of center legs and a frame body, and each of the center legs is disposed adjacent to each other in an accommodation space of the frame body. The coils are wound on each of the center legs respectively, and form magnetic flux paths between the center legs and the frame body. When each of the coils receives a current, the coils generate magnetic fluxes along each of the magnetic flux paths. The magnetic flux paths collectively pass through at least one portion of the frame body, so that the magnetic fluxes passing through a cross-sectional area of the frame body cancel each other out such that a frame magnetic flux in the at least one part of the frame body is smaller than a maximum value of the magnetic fluxes passing through the center legs.

In summary, the magnetic element with the magnetic flux compensation structure and its manufacturing method of the present invention, by arranging multiple sets of coils in the internal structure of the same core, can make the magnetic flux induced by each coil in the core cancel each other out and compensate for each other. Therefore, it can reduce iron loss and magnetic saturation, further reduce the heat generated by the power converter, and further improve the power conversion efficiency of the power converter. At the same time, it can also reduce the size of the transformer and inductor installed in the power converter.

### BRIEF DESCRIPTION OF THE DRAWINGS

FIGS. 1A and 1B are a schematic diagram and a schematic cross-sectional diagram, respectively, of an embodiment of a transformer.

FIG. 2A is a schematic diagram of another embodiment of a transformer.

FIG. 2B is a magnetic flux waveform diagram on a core of the transformer in FIG. 2A.

FIG. 2C is a combined magnetic flux waveform diagram of a top cover and a bottom frame on the transformer in FIG. 2A.

FIGS. 3A and 3B are a schematic diagram and a schematic cross-sectional diagram, respectively, of an embodiment of a transformer with the magnetic flux compensation structure of the present invention.

FIGS. 4A to 4C are schematic diagrams of transient changes in magnetic flux of the transformer with the magnetic flux compensation structure of the present invention in FIGS. 3A and 3B.

FIGS. 5A and 5B are a schematic diagram and a schematic cross-sectional diagram, respectively, of another embodiment of the transformer with the magnetic flux compensation structure of the present invention.

FIGS. 6A and 6B are a schematic diagram and a schematic cross-sectional diagram, respectively, of an inductor with the magnetic flux compensation structure of the present invention.

### DETAILED DESCRIPTION OF THE INVENTION

In the embodiments of the present invention, the magnetic elements include transformers and inductors, that is, the following content includes illustrations and implementation examples of transformers and inductors.

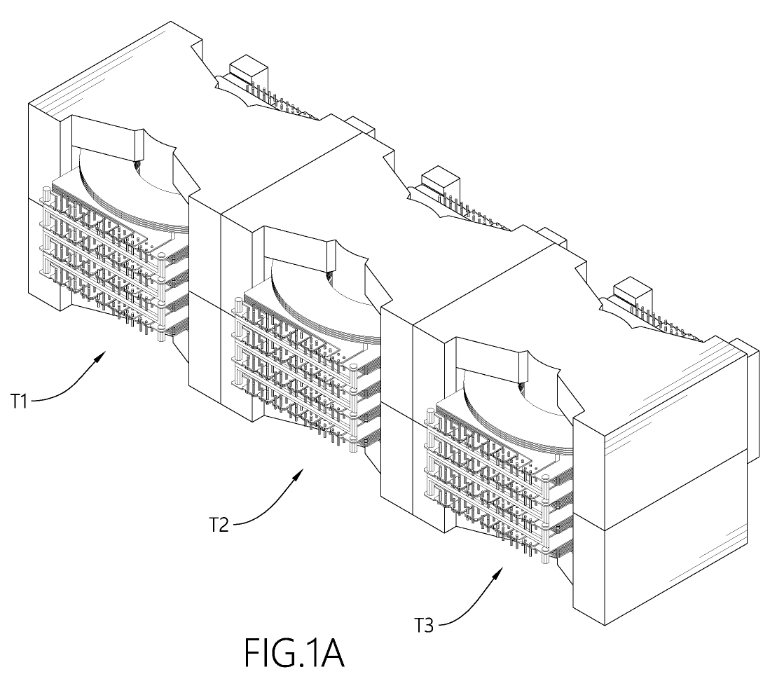

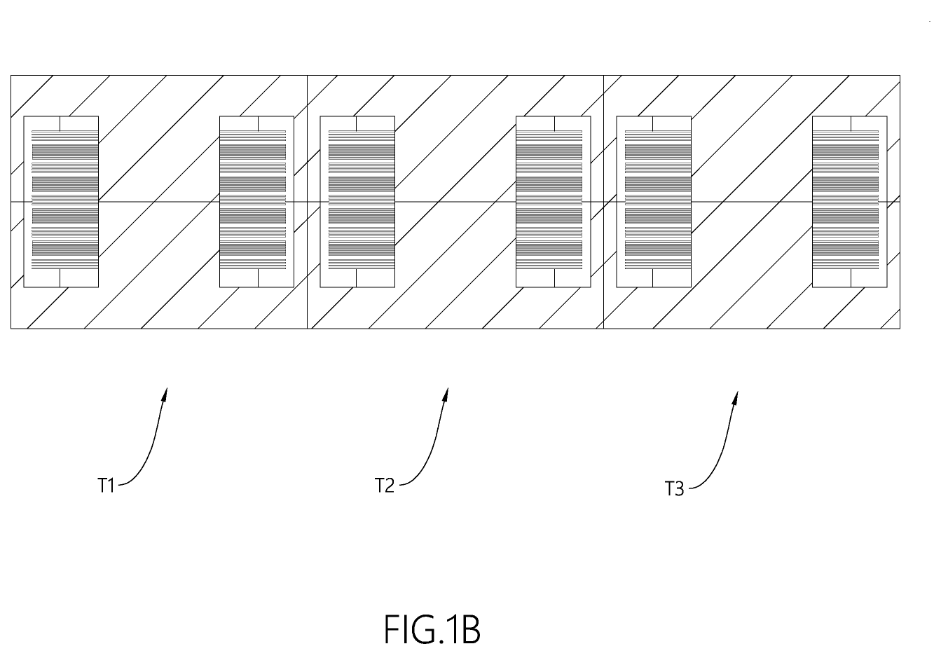

With reference to FIGS. 1A and 1B, 1A and 1B are a schematic diagram and a schematic cross-sectional diagram, respectively, of an embodiment of a transformer with a plurality of enclosed cores. As mentioned in the background of the invention, in addition to circuit architecture and component selection, the design of magnetic elements such as transformers and inductors is receiving increasing attention in the design of power converters. For example, for power converter architectures requiring 5 kW or more, a multi-phase design can resolve the limitations of single-phase systems. In FIGS. 1A and 1B, the multi-phase power converter utilizes an architecture based on three transformers T1, T2, and T3. Taking a three-phase full-bridge LLC circuit architecture as an example, adopting a three-phase LLC circuit architecture distributes thermal and current stress among components. Additionally, output current ripples can cancel each other out, thereby reducing the output current ripples and achieving high efficiency.

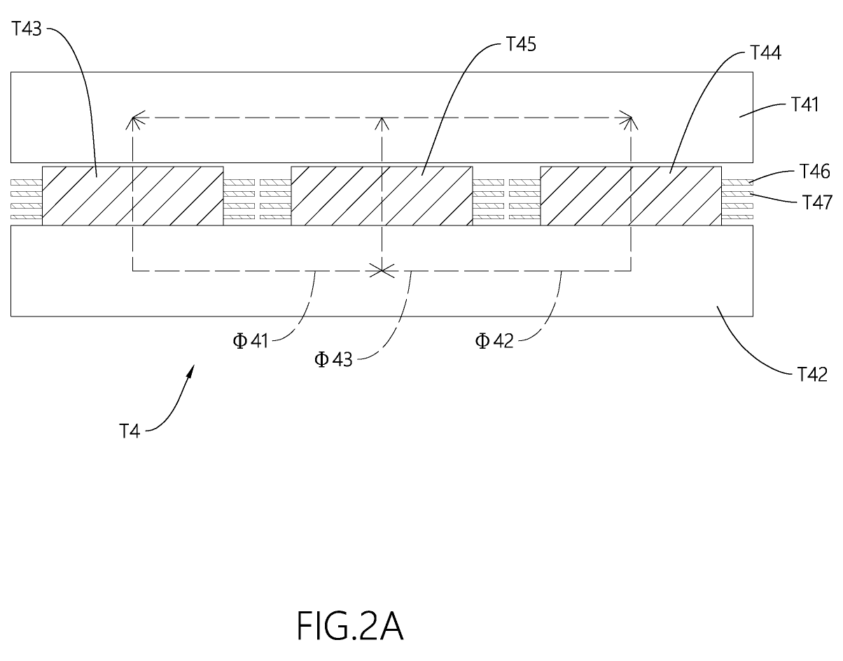

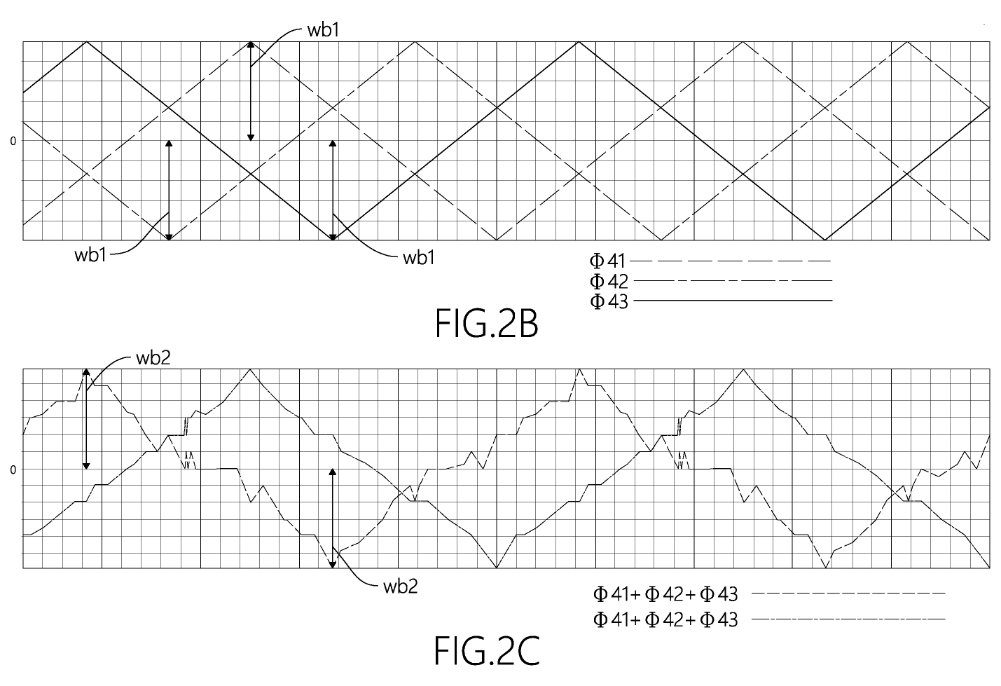

With reference to FIGS. 2A to 2C, 2A, is a schematic diagram of an embodiment of a transformer with a single accommodation space, and FIGS. 2B and 2C are schematic diagrams of transient changes. Additionally, FIG. 2B is a magnetic flux waveform diagram of the center legs of the core of the transformer, and FIG. 2C is a combined magnetic flux waveform diagram of a top cover and a bottom frame on the transformer.

As shown in FIG. 2A, a structure of the transformer T4 includes coils and a core, and the core includes a top cover T41, a bottom frame T42, and three center legs T43, T44, and T45. Each of the center legs T43, T44, and T45 is wound with coils, and receives a first current, a second current, and a third current respectively. Moreover, magnetic flux paths formed by the first current, the second current, and the third current between the top cover T41, the bottom frame T42 and the center legs T43, T44, T45 induce a first magnetic flux Φ41, a second magnetic flux Φ42, and a third magnetic flux Φ43. Each of the coils includes a primary coil T46 and a secondary coil T47, and when the primary coil T46 receives a current, the secondary coil T47 induces a magnetic flux according to the current.

As shown in FIG. 2B, a phase of the first magnetic flux Φ41 leads a phase of the second magnetic flux Φ42, and the phase of the second magnetic flux Φ42 leads a phase of the third magnetic flux Φ43. Therefore, the magnetic flux paths formed between the center legs T43, T44, and T45, the top cover T41, and the bottom frame T42 all pass through at least a portion of the top cover T41 and the bottom frame T42. Moreover, the cross-sectional areas of the top cover T41 and the bottom frame T42 cause at least a portion of the first magnetic flux Φ41, the second magnetic flux Φ42, and the third magnetic flux Φ43 to compensate each other. Therefore, the maximum value of the first magnetic flux Φ41, the second magnetic flux Φ42, and the third magnetic flux Φ43 passing through the top cover T41 and the bottom frame T42 is less than the first magnetic flux Φ41, the second magnetic flux Φ42, and the third magnetic flux Φ43 on each of the center legs.

As shown in FIGS. 2B and 2C , the maximum magnetic flux Wb1 on each of the center legs T43, T44, and T45 is 1, and the peak to peak magnetic flux Wb2 is 2. Moreover, in this embodiment, the accommodation space formed by the top cover T41 and the bottom frame T42 of the core of the transformer T4 is a single and non-enclosed accommodation space. Therefore, as can be seen from the magnetic flux waveform obtained from this embodiment, the transformer without side columns forming the non-enclosed accommodation space can only achieve the effect of compensating for or cancelling part of the magnetic flux on the top cover T41 and the bottom frame T42, and reduce part of the core volume and core loss.

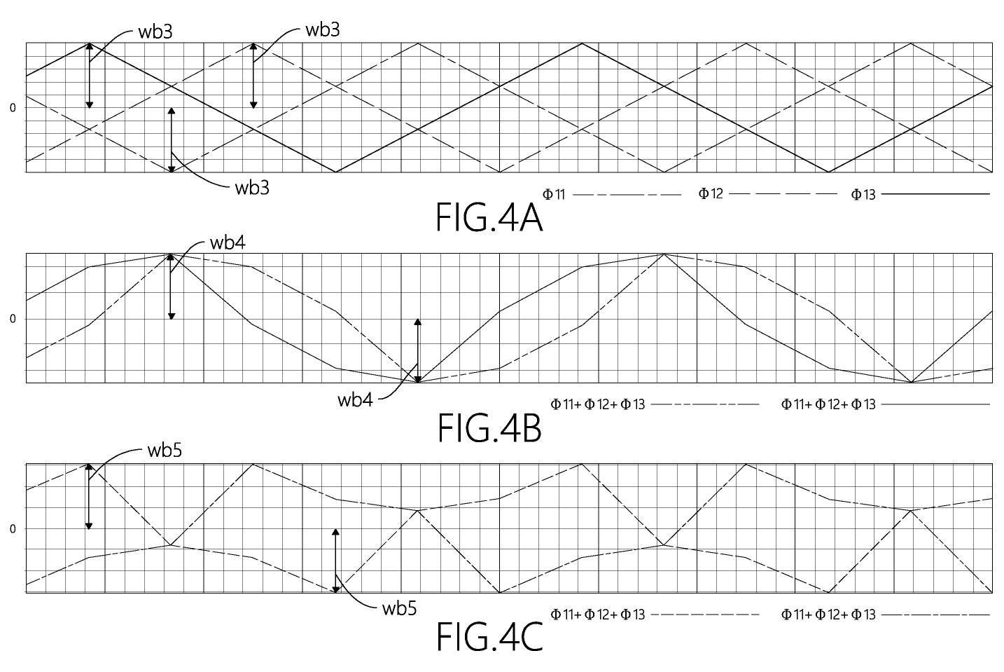

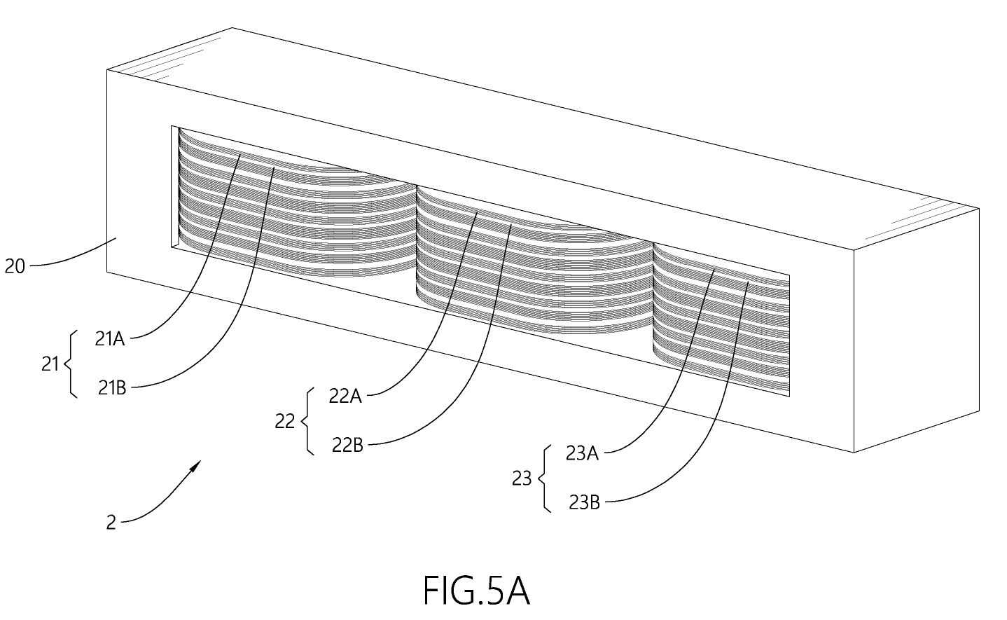

Furthermore, it should be noted that, in the embodiments of the present invention, the leading or lagging phase of either the current or the magnetic flux is used to indicate the phase difference relationship between the two currents and the two magnetic fluxes, and is not used to limit the absolute leading or lagging phase relationship between the two currents and the two magnetic fluxes. Moreover, since the change in phase current and magnetic flux is proportional, the change in magnetic flux described in the embodiments and figures of the present invention can be represented by the measurement of phase current in actual verification applications. That is, if the change in phase current measured on the transformer or inductor has a trend similar to that shown in FIGS. 2B to 2C and 4A to 4C and, it indicates that the transformer has the aforementioned magnetic flux compensation and cancellation effect.

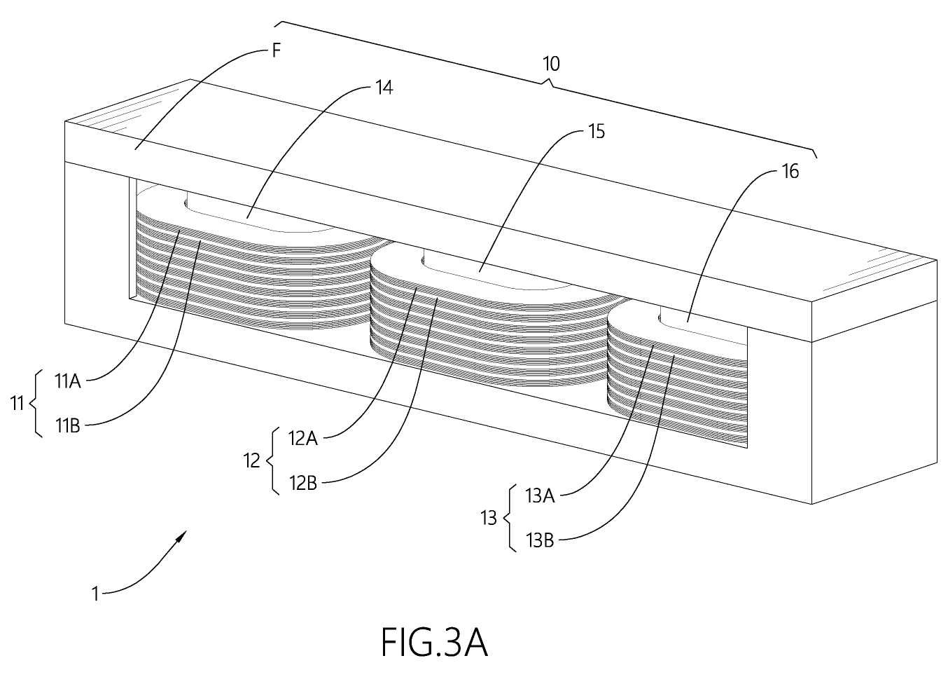

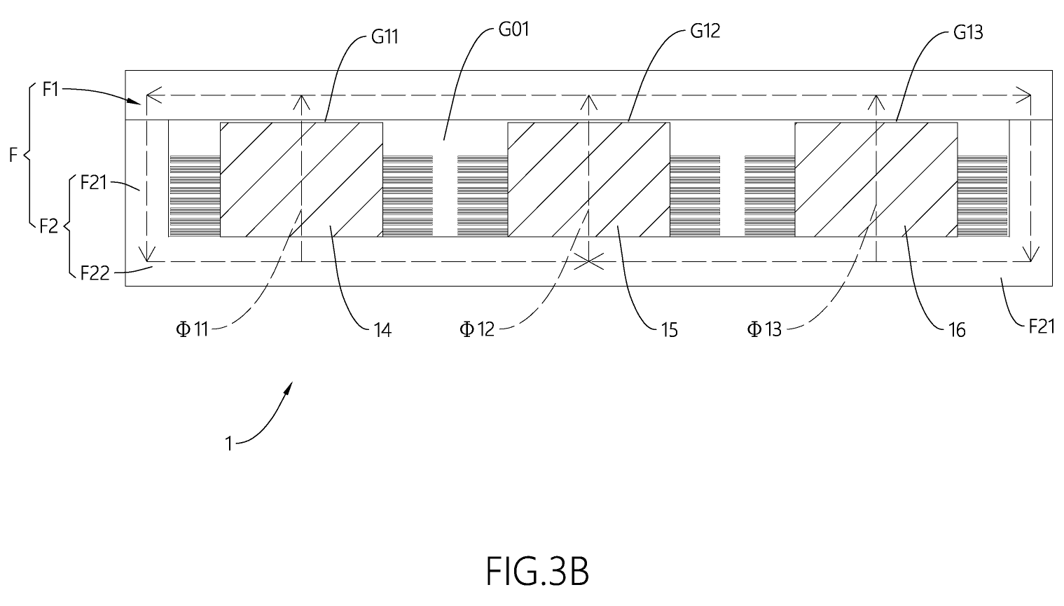

With reference to FIGS. 3A and 3B, FIGS. 3A and 3B and are a schematic diagram and a schematic cross-sectional diagram, respectively, of an embodiment of a transformer with the magnetic flux compensation structure of the present invention. In the embodiment, a transformer 1 with the magnetic flux compensation structure has a single enclosed accommodation space G01, and all of the coils and the center legs are placed in the single enclosed accommodation space G01. The transformer 1 includes a core 10, a first coil 11, and a second coil 22. The core 10 includes a first center leg 14, a second center leg 15, and a frame body F, and the first center leg 14 and the second center leg 15 are disposed adjacent to each other in the accommodation space G01. At least one first air gap G11 is formed between the first center leg 14 and the frame body F, and at least one second air gap G12 is formed between the second center leg 15 and the frame body F. Moreover, the at least one first air gap G11 and the at least one second air gap G12 communicate with the accommodation space G01.

The first coil 11 receives the first current, and generates a first magnetic flux Φ11 in a magnetic flux path formed between the frame body F and the first center leg 14; and the second coil 12 receives the second current, and generates a second magnetic flux Φ12 in a magnetic flux path formed between the frame body F and the second center leg 15.

The first coil 11 includes a first primary coil 11A and a first secondary coil 11B, and the first primary coil 11A and the first secondary coil 11B are wound on the first center leg 14. The first primary coil 11A receives the first current, which is a first primary current, causing the first secondary coil 11B to generate the first magnetic flux Φ11 based on the first primary current. Similarly, the second coil 12 includes a second primary coil 12A and a second secondary coil 12B, and the second primary coil 12A and the second secondary coil 12B are wound on the second center leg 15. The second primary coil 12A receives the second current, which is a second primary current, causing the second secondary coil 12B to generate the second magnetic flux Φ12 based on the second primary current. Moreover, a first current phase of the first primary current leads a second current phase of the second primary current, that is, a first magnetic flux phase of the first magnetic flux Φ11 leads a second magnetic flux phase of the second magnetic flux Φ12.

With reference to FIGS. 3A and 3B again, the transformer 1 with the magnetic flux compensation structure further includes a third center leg 16 and a third coil 13. The third center leg 16 is placed in the accommodation space G01. At least one third air gap G13 is formed between the third center leg 16 and the frame body F, and the third air gap G13 communicates with the accommodation space G01.

The third coil 13 receives the third current, and generates a third magnetic flux Φ13 in the magnetic flux path formed between the frame body F and the third center leg 16. The third coil 13 includes a third primary coil 13A and a third secondary coil 13B, and the third primary coil 13A and the third secondary coil 13B are wound on the third center leg 16. The third primary coil 13A receives the third current, which is a third primary current, causing the third secondary coil 13B to generate the third magnetic flux Φ13.

In comparison, the second current phase of the second primary current leads a third current phase of the third primary current, that is, the second magnetic flux phase of the second magnetic flux Φ12 leads a third magnetic flux phase of the third magnetic flux Φ13. The first magnetic flux phase leads the second magnetic flux phase, and the second magnetic flux phase leads the third magnetic flux phase. Therefore, the magnetic flux paths formed between the first center leg 14, the second center leg 15, the third center leg 16 and the frame body F collectively pass through at least one portion of the frame body F respectively. The first magnetic flux Φ11, the second magnetic flux Φ12, and the third magnetic flux Φ13 pass through a cross-sectional part of the frame body F to cancel each other out such that a frame magnetic flux in at least one part of the frame body F being less than a maximum value of the first magnetic flux Φ11, the second magnetic flux Φ12, and the third magnetic flux Φ13 on each center leg.

With reference to FIG. 3B again, in one embodiment of the present invention, the frame body F includes a top cover F1 and a bottom frame F2, and the bottom frame F2 includes two side center legs F21 and one bottom cover F22. The first center leg 14, the second center leg 15, and the third center leg 16 are shorter than the two side center legs F21, allowing the top cover F1 to cover the two side center legs F21 of the bottom frame F2. Moreover, the at least one first air gap G11 is formed between the first center leg 14 and the top cover F1, the at least one second air gap G12 is formed between the second center leg 15 and the top cover F1, and the at least one third air gap G13 is formed between the third center leg 16 and the top cover F1. Furthermore, the top cover F1 and the bottom frame F2 form the accommodation space G01. In one embodiment, the two side center legs F21, the bottom cover F22, the first center leg 14, the second center leg 15, and the third center leg 16 are molded in one piece.

With reference to FIGS. 3B and 4A to 4C to 4A to 4C, are schematic diagrams of transient changes in magnetic flux of the transformer with the magnetic flux compensation structure of the present invention in FIGS. 3A and 3B. 4A. shows the magnetic flux waveform of the transformer with the magnetic flux compensation structure on each center leg. FIG. 4B shows the magnetic flux compensation diagram of a three-phase transformer on the top cover and the bottom cover of the frame body. FIG. 4C shows the magnetic flux compensation diagram of a three-phase transformer on the two side center legs of the frame body.

The magnetic field passing through a curved surface is called magnetic flux. When a primary current flows through a coil, the coil induces a magnetic field that establishes a magnetic flux through the top cover F1, the two side center legs F21, and the bottom cover F22 of the frame body F. Furthermore, since an air gap is a path with higher impedance than the material of the frame body F, the magnetic flux will not travel through the air gap, effectively isolating the magnetic flux through each of the air gaps. Therefore, by setting up air gaps within the core 10, the magnetic flux induced by each coil within the core 10 can flow to the top cover F1, the two side center legs F21, and the bottom cover F22, avoiding mutual interference between the magnetic fluxes generated by the coils and further preventing any impact on the operation of the power converter.

Moreover, by controlling the phase difference between the currents of the aforementioned coils, the magnetic flux flowing through the top cover F1, the two side center legs F21, and the bottom cover F22 of the frame body F can be compensated or canceled out.

Furthermore, in the aforementioned embodiment of the transformer 1 with the magnetic flux compensation structure that only includes the first coil 11 and the second coil 12, when controlling the first current phase of the first current leading the second current phase of the second current by 180 degrees, the first magnetic flux Φ11 and the second magnetic flux Φ12 can be compensated for or can be cancelled out. That is, when the first magnetic flux phase of the first magnetic flux Φ11 and the second magnetic flux phase of the second magnetic flux Φ12 are opposite, the effect of compensation or cancellation can be produced.

In the aforementioned embodiment of the transformer 1 with the magnetic flux compensation structure that includes the first coil 11, the second coil 12, and the third coil 13, when controlling the first current phase leading the second current phase by 120 degrees, and controlling the second current phase leading the third current phase by 120 degrees, the first magnetic flux Φ11, the second magnetic flux Φ12, and the third magnetic flux Φ13 can be compensated for or can be cancelled out. That is, when the first magnetic flux phase, the second magnetic flux phase, and the third magnetic flux phase are the same or opposite, the effect of compensation or cancellation can be produced.

As shown in FIGS. 4B and 4C , although phase currents passing through the top cover F1, the bottom frame F22, and two side center legs F21 should include the phase currents on the first coil 11, the second coil 12, and the third coil 13, and correspondingly induce the first magnetic flux Φ11, the second magnetic flux Φ12, and the third magnetic flux Φ13, in actual measurement, it is impossible to individually measure the phase currents on the first coil 11, the second coil 12, and the third coil 13 through the top cover F1, the bottom cover F22, and the two side center legs F21. That is, it is also impossible to correspondingly measure the first magnetic flux Φ11, the second magnetic flux Φ12, and the third magnetic flux Φ13 that are individually induced of. Therefore, in FIG. 4B, the phantom line represents the sum of the first magnetic flux Ф11, the second magnetic flux Φ12, and the third magnetic flux Φ13 passing through the top cover F1, and the solid line represents the sum of the first magnetic flux Φ11, the second magnetic flux Φ12, and the third magnetic flux Φ13 passing through the bottom cover F22. In FIG. 4C, the dashed line represents the sum of the first magnetic flux Φ11, the second magnetic flux Ф12, and the third magnetic flux Φ13 passing through the left center leg, and the center line represents the sum of the first magnetic flux Φ11, the second magnetic flux Φ12, and the third magnetic flux Φ13 passing through the right center leg.

With reference to FIGS. 4A to 4C again. FIG. 4A shows the magnetic flux phases of the first magnetic flux Φ11, the second magnetic flux Φ12, and the third magnetic flux Φ13 before cancellation and compensation. FIG. 4B shows that when the magnetic flux phases of the first magnetic flux Φ11, the second magnetic flux Φ12, and the third magnetic flux Φ13 differ by 120 degrees and are the same or opposite, the magnetic fluxes flowing through the top cover F1 and the bottom cover F22 of the frame body F will cancel each other out or compensate for each other. However, the first magnetic flux Φ11, the second magnetic flux Φ12, and the third magnetic flux Φ13 flowing through the first center leg14, the second center leg 15, and the third center leg 16, respectively, will not have the effect of magnetic flux cancellation.

As shown in FIG. 4A, when the maximum magnetic flux Wb3 on the first center leg 14, the second center leg 15, and the third center leg 16 is 1, the peak-to-peak value will be 2, which is the double of Wb3. Then, in FIG. 4B, the maximum magnetic flux Wb4 on the top cover F1 and bottom cover F22 of the frame body F is 0.5, and the peak-to-peak value will be 1, which is the double of Wb4. FIG. 4C shows the result of mutual compensation and cancellation of the first magnetic flux Φ11, the second magnetic flux Φ12, and the third magnetic flux Φ13 flowing through the two side center legs F21 of the frame body F.

Compared with the results without canceled magnetic flux in FIG. 4A, it can be clearly seen that the transformer 1 with magnetic flux compensation structure of the present invention can effectively reduce the maximum value and peak-to-peak value of magnetic flux of the top cover F1, bottom cover F22 and two side center legs F21 of the frame body F. Reducing the maximum value of magnetic flux means that the volume of the core 10 of the transformer can be reduced, and reducing the peak-to-peak value of magnetic flux means that the loss (iron loss) of the core 10 of the transformer can be reduced. That is, the transformer 1 with magnetic flux compensation structure of the present invention can simultaneously reduce the volume of the core 10 and the iron loss.

As mentioned above, based on magnetic saturation characteristics, increasing the magnetic field intensity of the core 10 made with ferromagnetic material will cause the ferromagnetic material to magnetize, leading to a corresponding increase in magnetic flux density. However, once the magnetic field intensity reaches a certain threshold, the magnetic flux density increases only slightly until it reaches a limit due to the permeability of free space. This phenomenon is known as magnetic saturation. The saturation magnetic flux density of a typical core 10 is approximately 0.3.

According to the formulas in physics, magnetic flux (Φ) is the product of magnetic flux density (B) and cross-sectional area (Area). When the magnetic flux density reaches saturation, the cross-sectional area of the core 10 of the transformer can be calculated by calculating the magnetic flux, and further, the volume of the core 10 of the transformer can be calculated. For the calculation of magnetic flux, the magnitude of the primary current input to the transformer can be calculated based on the maximum output power of the circuit structure corresponding to the transformer structure, and the magnitude of the magnetic flux can be further calculated from the magnitude of the primary current. Therefore, as described above, by reducing the calculated maximum magnetic flux, the volume of the core 10 of the transformer can be further calculated, as well as the reduction in iron loss. In other words, the cross-sectional area of the frame body F of the transformer 1 with the magnetic flux compensation structure is calculated based on the magnetic flux saturation density of the core’s material and the magnitudes of the first magnetic flux Φ11, the second magnetic flux Φ12, and the third magnetic flux Φ13 flowing through that cross-sectional area, and the volume of the core 10 can be further calculated based on the cross-sectional area of the frame body F.

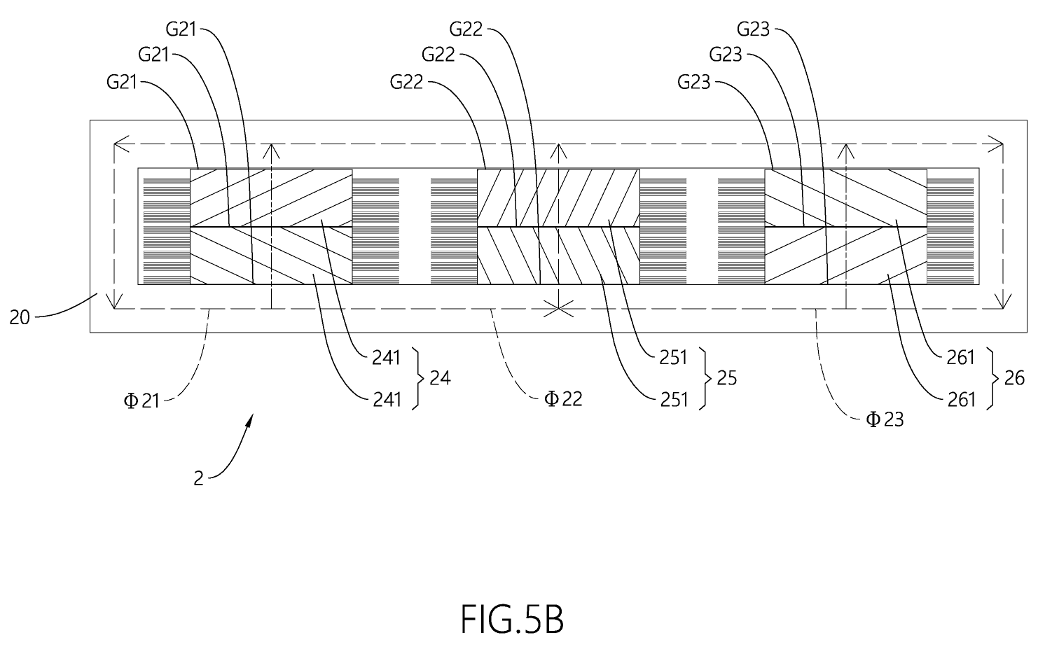

With reference to FIGS. 5A and 5B, 5A and 5B, and are a schematic diagram and a schematic cross-sectional diagram, respectively, of another embodiment of the transformer with the magnetic flux compensation structure of the present invention. In the embodiment, a transformer 2 with the magnetic flux compensation structure has a single enclosed accommodation space G02, and all of the coils and the center legs are placed in the single enclosed accommodation space G02. The transformer 2 includes a core 20, a first coil 21, a second coil 22, a third coil 23, a first center leg 24, a second center leg 25, and a third center leg 26. Specifically, the core 20 includes the accommodation space G02, and the first coil 21, the second coil 22, the third coil 23, the first center leg 24, the second center leg 25, and the third center leg 26 are placed in the accommodation space G02.

The first coil 21 includes a first primary coil 21A and a first secondary coil 21B, and the first primary coil 21A and the first secondary coil 21B are wound on the first center leg 24. The first primary coil 21A receives a first current, which is a first primary current, causing the first secondary coil 21B to generate a first magnetic flux Φ21 based on the first primary current. Similarly, the second coil 22 includes a second primary coil 22A and a second secondary coil 22B, and the second primary coil 22A and the second secondary coil 22B are wound on the second center leg 25. The second primary coil 22A receives a second current, which is a second primary current, causing the second secondary coil 22B to generate the second magnetic flux Φ22 based on the second primary current. The third coil 23 includes a third primary coil 23A and a third secondary coil 23B, and the third primary coil 23A and the third secondary coil 23B are wound on the third center leg 26. The third primary coil 23A receives a third current, which is a third primary current, causing the third secondary coil 23B to generate the third magnetic flux Ф23 based on the third primary current.

The first coil 21, the second coil 22, and the third coil 23 respectively form the first magnetic flux Φ21, the second magnetic flux Φ22, and the third magnetic flux Φ23 on the core 20, which have leading and lagging phases respectively, so as to produce magnetic flux compensation and cancellation effects. Since a first magnetic flux phase of the first magnetic flux Φ21 leads a second magnetic flux phase of the second magnetic flux Φ22, and the second magnetic flux phase of the second magnetic flux Φ22 leads a third magnetic flux phase of the third magnetic flux Φ23, the magnetic flux paths formed between the first center leg 24, the second center leg 25, and the third center leg 26 and the frame body of the core 20 all pass through at least one portion of the frame body. Furthermore, the first magnetic flux Φ21, the second magnetic flux Φ22, and the third magnetic flux Φ23 pass through a cross-sectional part of the frame body to cancel each other out such that a frame magnetic flux in at least one part of the frame body is less than a maximum value of the first magnetic flux Φ21, the second magnetic flux Φ22, and the third magnetic flux Φ23 on each center leg.

The difference between the core 10 and the core 20 is that the core 20 is molded in one piece, and the first center leg 24 includes a plurality of first magnetic flux center legs 241, the second center leg 25 includes a plurality of second magnetic flux center legs 251, and the third center leg 26 includes a plurality of third magnetic flux center legs 261. In the embodiment, the first magnetic flux center legs 241 are stacked to form the first center leg 24, the second magnetic flux center legs 251 are stacked to form the second center leg 25, and the third magnetic flux center legs 261 are stacked to form the third center leg 26. In addition, multiple first air gaps G21 are formed between the first magnetic flux center legs 241 and between the multiple first magnetic flux center legs 241 and the core 20; multiple second air gaps G22 are formed between the second magnetic flux center legs 251 and between the second magnetic flux center legs 251 and the core 20; and multiple third air gaps G23 are formed between the third magnetic flux center legs 261 and between the third magnetic flux center legs 261 and the core 20. The first air gaps G21, the second air gaps G22, and the third air gaps G23 communicate with the accommodation space G02.

In this embodiment, by forming a multi-segment air gap structure between each center leg and between each center leg and the core 20, the maximum value of the magnetic flux induced by each coil can be reduced, and the loss of the core 20 can be further reduced, thus reducing iron loss. Each of the multiple first air gaps G21, the multiple second air gaps G22, and the multiple third air gaps G23 is filled with a non-magnetic material. In this embodiment of the invention, the non-magnetic material includes adhesive to bond the magnetic flux center legs in each center leg.

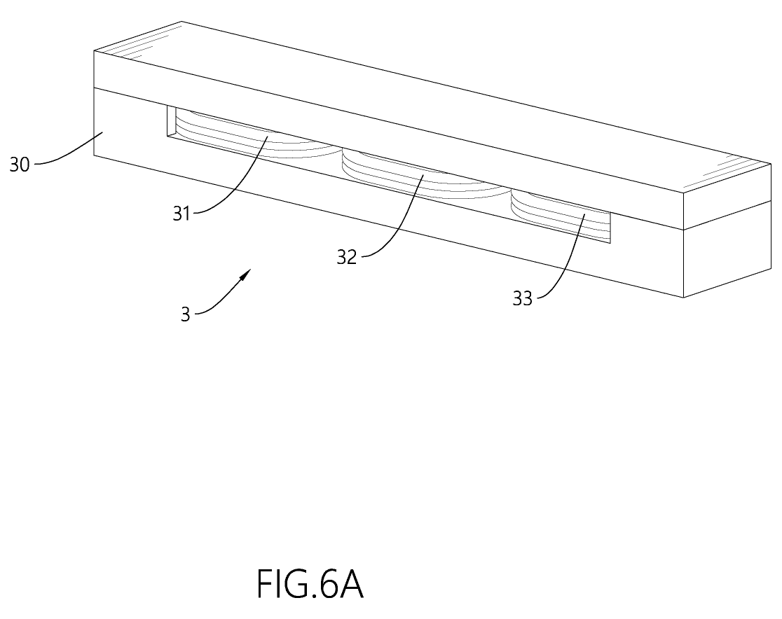

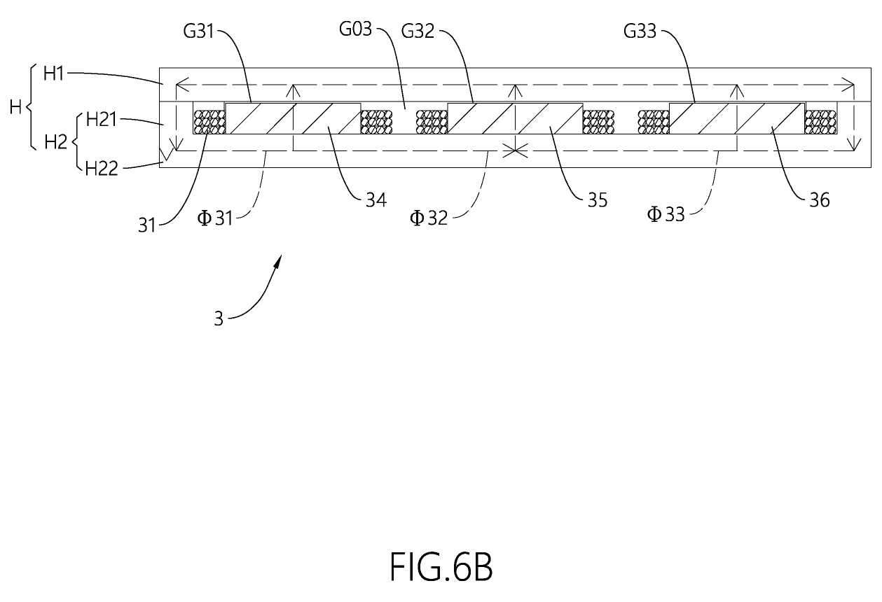

With reference to FIGS. 6A and 6B, 6A and 6B are a schematic diagram and a schematic cross-sectional diagram, respectively, of an inductor with the magnetic flux compensation structure of the present invention. In the embodiment, an inductor 3 with the magnetic flux compensation structure includes a core 30, a first coil 31, and a second coil 32. The core 30 includes a first center leg 34, a second center leg 35, and a frame body H, and the first center leg 34 and the second center leg 35 are placed in an accommodation space G03 formed by the frame body H. The first coil 31 is wound on the first center leg 34, receiving a first current, and generating a first magnetic flux Φ31 according to the first current. The second coil 32 is wound on the second center leg 35, receiving a second current, and generating a second magnetic flux Φ32 according to the second current. Moreover, a first current phase of the first current leads a second current phase of the second current, that is, a first magnetic flux phase of the first magnetic flux Ф31 leads a second magnetic flux phase of the second magnetic flux Ф32. At least one first air gap G31 and at least one second air gap G32 are respectively formed between the first center leg 34 and the core 30, and between the second center leg 35 and the core 30, and the at least one first air gap G31 and the at least one second air gap G32 communicate with the accommodation space G03.

With reference to FIGS. 6A and 6B again, the inductor 3 with the magnetic flux compensation structure further includes a third center leg 36 and a third coil 33. The third center leg 36 is placed in the accommodation space G03, and the third coil 33 is wound on the third center leg 36. The frame body H includes a top cover H1 and a bottom frame H2, and the bottom frame H2 includes two side center legs H21 and a bottom cover H22. The top cover H1 covers the two side center legs H21 to form the third accommodation space G03. Moreover, the bottom cover H22, the two side center legs H21, the first center leg 34, the second center leg 35, and the third center leg 36 are molded in one piece. Furthermore, the first center leg 34, the second center leg 35, and the third center leg 36 are shorter than the two side center legs H21, which forms the first air gap G31, the second air gap G32, and a third air gap G33 respectively between the first center leg 34 and the top cover H1, between the second center leg 35 and the top cover H1, and between the third center leg 36 and the top cover H1. The third air gap G33 also communicates with the accommodation space G03.

The third coil 33 receives a third current, and generates a third magnetic flux Φ33 based on the third current. The second current phase of the second current leads a third current phase of the third current, such that the second magnetic flux phase of the second magnetic flux Φ32 leads a third magnetic flux phase of the third magnetic flux Φ33. Similarly, by controlling the first current phase to lead the second current phase by 180 degrees, the first magnetic flux Φ31 and the second magnetic flux Φ32 can be compensated or canceled. Alternatively, in the embodiment of the inductor 3 with the magnetic flux compensation structure, which includes the first coil 31, the second coil 32, and the third coil 33, by controlling the first current phase to lead the second current phase by 120 degrees, and the second current phase to lead the third current phase by 120 degrees, the first magnetic flux Φ31, the second magnetic flux Φ32, and the third magnetic flux Φ33 can be compensated or canceled. Since the first magnetic flux phase of the first magnetic flux Φ31 leads the second magnetic flux phase of the second magnetic flux Φ32, and the second magnetic flux phase of the second magnetic flux Φ32 leads the third magnetic flux phase of the third magnetic flux Φ33, the magnetic flux paths formed between the first center leg 34, the second center leg 35, the third center leg 36 and the frame body H all pass through at least one portion of the frame body H. Furthermore, the first magnetic flux Φ31, the second magnetic flux Φ32, and the third magnetic flux Φ33 pass through a cross-sectional area of the frame body H to cancel each other out such that a frame magnetic flux in at least one part of the frame body H is less than a maximum value of the first magnetic flux Φ31, the second magnetic flux Φ32, and the third magnetic flux Φ33 on each center leg.

In contrast, the magnetic element with magnetic flux compensation structure and its manufacturing method of the present invention can be applied not only to the structure of transformers but also to inductors. That is, the magnetic element can be selectively installed in the circuits of various power converters, or both the transformers 1 and 2 with magnetic flux compensation structure and the inductor 3 with magnetic flux compensation structure of the present invention can be installed simultaneously. The main difference between the transformers 1 and 2 with magnetic flux compensation structure and the inductor 3 with magnetic flux compensation structure is that the transformers 1 and 2 with magnetic flux compensation structure include a primary coil and a secondary coil, while the inductor 3 with magnetic flux compensation structure includes a single-polarity coil. Therefore, the magnetic flux compensation principle and content of the inductor 3 with magnetic flux compensation structure are as described above for the transformers 1 and 2 with magnetic flux compensation structure, and will not be repeated here.

In summary, the magnetic element with magnetic flux compensation structure and its manufacturing method of the present invention, by arranging multiple sets of coils within the same core structure and reducing the number of side center legs, allows the magnetic flux induced by each coil within the core to cancel and compensate for each other. Furthermore, the air gap design avoids mutual interference between the magnetic flux generated by the coils, thereby reducing iron loss and magnetic saturation, further reducing the heat generated by the power converter, and further improving the power conversion efficiency of the power converter.

In addition, the multi-segment air gap design disperses a single air gap into multiple smaller air gaps, achieving the effect of reducing air gap loss and further improving the power conversion efficiency of the power converter. Moreover, the magnetic element with magnetic flux compensation structure and its manufacturing method of the present invention, by arranging multiple sets of coils within the same core structure and reducing the number of side center legs, further achieves the effect of reducing the overall size of the magnetic element.

Furthermore, the magnetic element with magnetic flux compensation structure and its manufacturing method of the present invention improve power conversion efficiency in power converters by reducing the size of the magnetic element and increasing its conversion efficiency.

Additionally, when the magnetic element with magnetic flux compensation structure and its manufacturing method of the present invention are applied to the magnetic elements of transformers and inductors, by integrating a polynomial transformer, the transformers and the inductors can be widely used in single-phase full-bridge LLC circuits, three-phase LLC circuits, three-phase LLC resonant inductor circuits, phase-shifted full-bridge circuits, and other circuit architectures. They can also be extended to multi-phase circuits with integrated magnetic components, such as four-phase, five-phase, and six-phase circuits. This allows various circuits to improve transformer conversion efficiency and reduce the size of transformers and inductors in various circuits, such as single-phase full-bridge LLC circuits, three-phase LLC circuits, and three-phase LLC resonant inductor circuits, while reducing iron losses, heat generation, and magnetic saturation by reducing the maximum magnetic flux.

What is claimed is:

1. A magnetic element with magnetic flux compensation structure, the magnetic element comprising:
a core, comprising a plurality of center legs and a frame body; wherein, each of the center legs is disposed adjacent to each other in an accommodation space of the frame body; and
a plurality of coils, wound on each of the center legs respectively, and forming magnetic flux paths between the center legs and the frame body; wherein when each of the coils receives a current, the coils generate magnetic fluxes along each of the magnetic flux paths;
wherein, the magnetic flux paths collectively pass through at least one portion of the frame body;
wherein, the magnetic fluxes passing through a cross-sectional area of the frame body cancel each other out such that a frame magnetic flux in the at least one part of the frame body is smaller than a maximum value of the magnetic fluxes passing through the center legs.

2. The magnetic element with magnetic flux compensation structure as claimed in claim 1, wherein, the plurality of center legs comprise a first center leg and a second center leg, the plurality of coils comprise a first coil and a second coil, the current comprises a first current and a second current, the magnetic fluxes comprise a first magnetic flux and a second magnetic flux;
wherein, the first center leg and the second center leg are disposed adjacent to each other in the accommodation space, and the first coil and the second coil are respectively wound on the first center leg and the second center leg;
wherein, when the first coil receives the first current, the first coil generates the first magnetic flux, and when the second coil receives the second current, the second coil generates the second magnetic flux.

3. The magnetic element with magnetic flux compensation structure as claimed in claim 2, wherein, a first current phase of the first current leads a second current phase of the second current to cause a first magnetic flux phase of the first magnetic flux to lead a second magnetic flux phase of the second magnetic flux, and to cause the first magnetic flux and the second magnetic flux passing through the cross-sectional area to cancel each other out.

4. The magnetic element with magnetic flux compensation structure as claimed in claim 3, wherein, at least one first air gap is formed between the first center leg and the frame body, and at least one second air gap is formed between the second center leg and the frame body;
wherein, the at least one first air gap and the at least one second air gap communicate with the accommodation space.

5. The magnetic element with magnetic flux compensation structure as claimed in claim 4, wherein the plurality of center legs further comprise a third center leg, the plurality of coils further comprise a third coil, the current further comprises a third current, and the magnetic fluxes further comprise a third magnetic flux;
wherein, the third center leg and the second center leg are disposed adjacent to each other in the accommodation space, the third coil is wound on the third center leg, and when the third coil receives the third current, the third coil generates the third magnetic flux;
wherein, the first current, the second current, and the third current form a three-phase current, and the second current phase of the second current leads a third current phase of the third current to cause the second magnetic flux phase of the second magnetic flux to lead a third magnetic flux phase of the third magnetic flux, and causing the first magnetic flux, the second magnetic flux, and the third magnetic flux passing through the cross-sectional area to cancel each other out;
wherein, at least one third air gap is formed between the third center leg and the frame body and the at least one third air gap communicates with the accommodation space.

6. The magnetic element with magnetic flux compensation structure as claimed in claim 1, wherein, the accommodation space formed by the frame body is a single accommodation space.

7. The magnetic element with magnetic flux compensation structure as claimed in claim 1, wherein, the frame body of the core is a closed frame body.

8. The magnetic element with magnetic flux compensation structure as claimed in claim 5, wherein, the first magnetic flux, the second magnetic flux, and the third magnetic flux pass through the cross-sectional area, and the cross-sectional area is calculated according to a saturation flux density of a material of the core, a first magnetic flux magnitude, a second magnetic flux magnitude, and a third magnetic flux magnitude;
wherein, a volume of the core is calculated according to the cross-sectional area of the frame body.

9. The magnetic element with magnetic flux compensation structure as claimed in claim 5, wherein, the frame body comprises a top cover and a bottom frame, and the bottom frame comprises two side center legs and a bottom cover;
wherein, the first center leg, the second center leg, and the third center leg are shorter than the two side center legs, and the top cover covers the two side center legs of the bottom frame;
wherein, the at least one first air gap is formed between the first center leg and the top cover, the at least one second air gap is formed between the second center leg and the top cover, and the at least one third air gap is formed between the third center leg and the top cover.

10. The magnetic element with magnetic flux compensation structure as claimed in claim 5, wherein, the first center leg comprises a plurality of first magnetic flux center legs, and the first magnetic flux center legs are stacked to form the first center leg;
wherein, the at least one first air gap is multiple, and the multiple first air gaps are respectively formed between the first magnetic flux center legs, and between the first magnetic flux center legs and the frame body;
wherein, the second center leg comprises a plurality of second magnetic flux center legs, and the second magnetic flux center legs are stacked to form the second center leg;
wherein, the at least one second air gap is multiple, and the multiple second air gaps are respectively formed between the second magnetic flux center legs, and between the second magnetic flux center legs and the frame body;
wherein, the third center leg comprises a plurality of third magnetic flux center legs, and the third magnetic flux center legs are stacked to form the third center leg;
wherein, the at least one third air gap is multiple, and the multiple third air gaps are respectively formed between the third magnetic flux center legs, and between the third magnetic flux center legs and the frame body.

11. The magnetic element with magnetic flux compensation structure as claimed in claim 10, wherein, the first air gaps, the second air gaps, and the third air gaps are filled with a non-magnetic material respectively.

12. The magnetic element with magnetic flux compensation structure as claimed in claim 5, wherein, the first coil comprises a first primary coil and a first secondary coil, and the first secondary coil generates the first magnetic flux while the first primary coil receives the first current;
wherein, the second coil comprises a second primary coil and a second secondary coil, and the second secondary coil generates the second magnetic flux while the second primary coil receives the second current.

13. The magnetic element with magnetic flux compensation structure as claimed in claim 12, wherein, the third coil comprises a third primary coil and a third secondary coil, and the third secondary coil generates the third magnetic flux while the third primary coil receives the third current.

14. The magnetic element with magnetic flux compensation structure as claimed in claim 13, wherein, the magnetic element comprises a transformer or an inductor.

15. A manufacturing method of a magnetic element with magnetic flux compensation structure, comprising:
providing a core of a magnetic element; wherein, the core comprises a plurality of center legs and a frame body, and each of the center legs is disposed adjacent to each other in an accommodation space of the frame body; and
winding coils on each of the center legs respectively, to form magnetic flux paths between the center legs and the frame body; wherein when each of the coils receives a current, the coils generate magnetic fluxes along each of the magnetic flux paths;
wherein, the magnetic flux paths collectively pass through at least one portion of the frame body, and induce a frame magnetic flux on the frame body;
wherein, the frame magnetic flux is smaller than a maximum value of the magnetic flux passing through each of the center legs.

16. A magnetic element with magnetic flux compensation structure, the magnetic element comprising:
a core, comprising a first center leg, a second center leg, a third center leg, and a frame body; wherein, the first center leg, the second center leg, and the third center leg are disposed adjacent to each other in an accommodation space of the frame body;
a first coil, wound on the first center leg, forming a first magnetic flux path between the first center leg and the frame body; wherein when the first coil receives a first current, the first coil generates a first magnetic flux along the first magnetic flux path;
a second coil, wound on the second center leg, forming a second magnetic flux path between the second center leg and the frame body; wherein when the second coil receives a second current, the second coil generates a second magnetic flux along the second magnetic flux path;
a third coil, wound on the third center leg, forming a third magnetic flux path between the third center leg and the frame body; wherein when the third coil receives a third current, the third coil generates a third magnetic flux along the third magnetic flux path;
wherein, the first magnetic flux path, the second magnetic flux path, and the third magnetic flux path collectively pass through at least one portion of the frame body;
wherein, the first magnetic flux, the second magnetic flux, and the third magnetic flux passing at least one part of the frame body are smaller than a maximum value of the first magnetic flux, a maximum value of the second magnetic flux, and a maximum value of the third magnetic flux;
wherein, a first air gap is formed between the first center leg and the frame body, a second air gap is formed between the second center leg and the frame body, and a third air gap is formed between the third center leg and the frame body;
wherein, the first air gap, the second air gap, and the third air gap communicate with the accommodation space;
wherein, the first current, the second current, and the third current form a three-phase current, and the second current phase of the second current leads a third current phase of the third current to cause the second magnetic flux phase of the second magnetic flux to lead a third magnetic flux phase of the third magnetic flux, and to cause the first magnetic flux, the second magnetic flux, and the third magnetic flux passing through the cross-sectional area to cancel each other out.
